(19) United States
(12) Patent Application Publication
(10) Pub. No.: US 2018/0210460 A1
(43) Pub. Date: Jul. 26, 2018

(54) Control of Autonomous Vehicles

(71) Applicants: James Rowley, Henderson, NV (US); Mark Omo, Oro Valley, AZ (US)

(72) Inventors: James Rowley, Henderson, NV (US); Mark Omo, Oro Valley, AZ (US)

(21) Appl. No.: 15/412,772

(22) Filed: Jan. 23, 2017

(51) Int. Cl. G05D 1/02; G05D 1/00; G07C 5/00; G01C 21/20

(52) U.S. Cl. CPC G05D 1/0291; G01C 21/20; G07C 5/008; G05D 1/0088

(57) ABSTRACT

A method to simultaneously control a plurality of autonomous vehicles, wherein the method provides one or more autonomous vehicles, an autonomous vehicle controller comprising a controller processor and a controller non-transitory computer readable medium, having controller computer readable code encoded herein, and a controller task queue. The method wirelessly provides a task to an autonomous vehicle, and wirelessly provides a task completion message from that autonomous vehicle to the autonomous vehicle controller.

### FIELD OF THE INVENTION

Applicants' disclosure relates to a method of controlling autonomous vehicles. In certain embodiments, this disclosure is directed to controlling a plurality of unmanned vehicles.

### BACKGROUND OF THE INVENTION

An early unmanned vehicle was applied to military purpose such as aerial targets and reconnaissance. Recently, the military drone has been used for remote attack mission. And also, the drone for hobby has been commercially available by affordable price. Furthermore, one of most promising drone application would be the delivery of commercial packages to consumers. In 2013, Amazon announced plans for 30 minute delivery of individual packages to consumers by drone. Other commercial application of drone technology have been introduced explosively.

There is a great demand on the system of controlling plurality of drones for commercial applications. Several methods were applied to control plurality of unmanned mobile vehicles (UMV) for various applications such as the monitor of a geographic area and traffic. Each UMV was programmed with operational plan to cover a specific geographic area and includes onboard system that executes an operational plan. The method of controlling UAVs as a flock was proposed for aerial shows of UAVs within limited range.

### SUMMARY OF THE INVENTION

A method to simultaneously control a plurality of autonomous vehicles is disclosed. The method provides (N) autonomous vehicles, wherein (N) is greater than or equal to 1, wherein an each autonomous vehicle comprises a processor, a non-transitory computer readable medium having computer readable code encoded therein. The method further provides an autonomous vehicle controller comprising a controller processor, a controller non-transitory computer readable medium, having controller computer readable code encoded herein, and a controller task queue. The method wirelessly provides a task to an autonomous vehicle, and that autonomous vehicle wirelessly provides a task completion message to the autonomous vehicle controller.

An autonomous vehicle is disclosed. Applicants' autonomous vehicle comprises a processor, a non-transitory computer readable medium in communication with the processor, and computer readable program code encoded in the non-transitory computer readable medium, to receive and perform one or more tasks from an autonomous vehicle controller, the computer readable program code comprising a series of computer readable program steps to effect wirelessly receiving a task from an autonomous vehicle controller, performing that task by the autonomous vehicle, wirelessly providing a task completion message from the autonomous vehicle to the autonomous vehicle controller.

A computer program product encoded in a non-transitory computer readable medium is disclosed. The non-transitory computer readable medium is disposed in an autonomous vehicle comprising a microprocessor, the computer program product being useable with the microprocessor to receive and perform one or more tasks from an autonomous vehicle controller, comprising computer readable program code which causes the programmable processor to wirelessly receive a task from an autonomous vehicle controller, to perform that task by the autonomous vehicle, to wirelessly provide a task completion message from the autonomous vehicle to the autonomous vehicle controller or to wirelessly provide task failure message to the autonomous vehicle controller.

An autonomous vehicle controller is disclosed. The autonomous vehicle controller comprises a processor, a non-transitory computer readable medium, computer readable program code encoded in said non-transitory computer readable medium, and a controller vehicle task queue, to simultaneously control a plurality of autonomous vehicle, the computer readable program code comprising a series of computer readable program steps to effect wirelessly providing a task to a first autonomous vehicle, when receiving a task completion message from said first autonomous vehicle marking said task in said controller task queue as completed, when not receiving a task completion message from said first autonomous vehicle assigning said task to a second autonomous vehicle.

A computer program product encoded in a non-transitory computer readable medium disposed in an autonomous vehicle controller comprising a microprocessor and a controller task queue is disclosed. The computer program product is useable by the microprocessor to simultaneously control a plurality of autonomous vehicle, comprising computer readable program code which causes said programmable processor to wirelessly provide a task to a first autonomous vehicle; computer readable program code which, when receiving a task completion message from said first autonomous vehicle, causes said programmable processor to mark said task in said controller vehicle task queue as completed; and computer readable program code which, when not receiving a task completion message from the first autonomous vehicle, causes the programmable processor to assign the task to a second autonomous vehicle.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates Applicants' control system;

FIG. 2 summarizes Applicants' method to control a plurality of autonomous vehicles.

FIG. 3 summarizes the control hardware and software disposed in each of Applicants' drones, including a drone daemon;

FIG. 4 summarizes a method implemented by Applicants' drone daemon.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Applicants disclose a system for autonomously managing and controlling one or more unmanned vehicles is disclosed. The system comprises a central computer or computer bank, the necessary radio equipment to communicate with the unmanned vehicles, and the control software. The system is task-oriented, commanding any drones connected to it to complete the most efficient tasks for those drones. Tasks are added to the system by external sources such as humans or other systems, can contain actions such as taking a photograph, creating an aerial map, or recording sensor readings, and are associated with a physical/geographical point, path, or area. The system additionally incorporates functionality to retrieve data resulting from a task from the drone or drones performing that task and return it to the source originating that task.

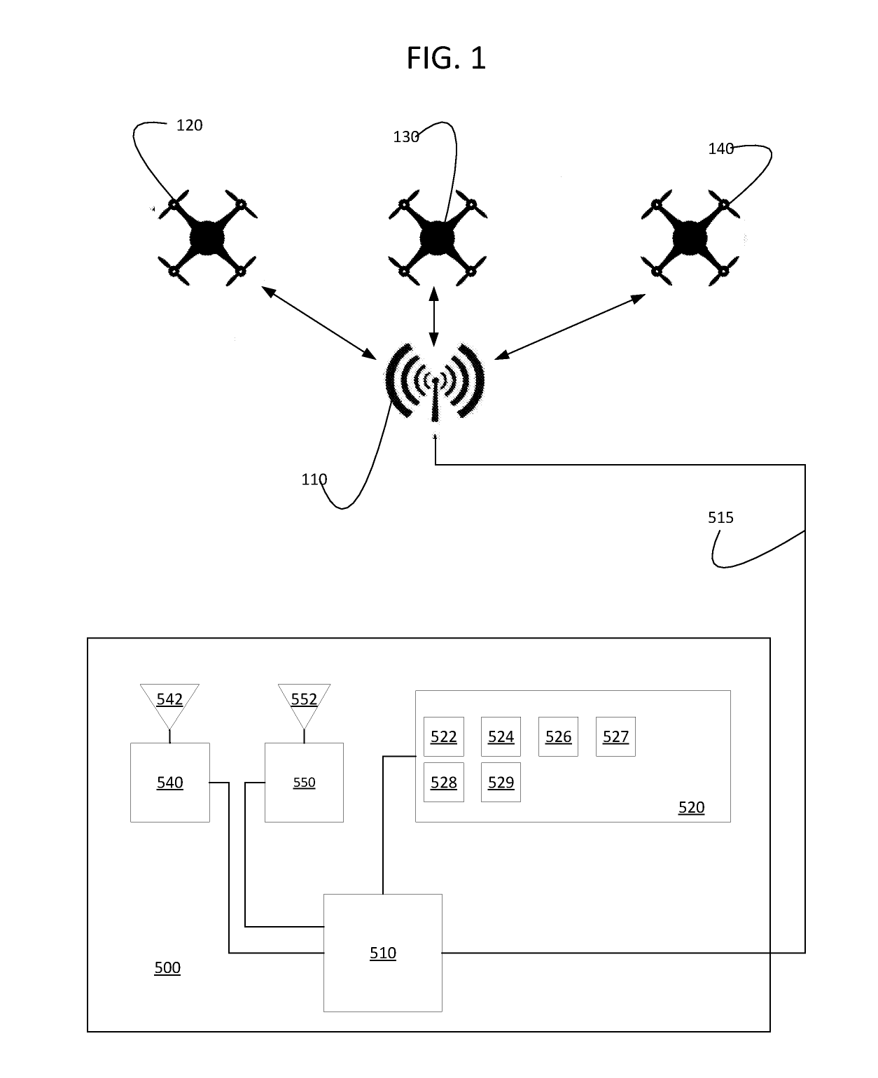

Referring now to FIG. 1, autonomous vehicle controller 500 comprises processor 510, non-transitory computer readable memory 520 interconnected with processor 510 via communication link 525, Blue Tooth module 540 interconnected with processor 510 via communication link 545, and optional wireless communication module 550 interconnected with processor 510 via communication link 555. By way of example and not limitation, wireless communication module 550 may utilize a cellular service, WI-FI, or any other wireless communication protocol.

As those skilled in the art will appreciate, wireless communications module 550 comprises a wireless network permitting communication with one or more external computers or programmable devices in a network or with point-to-point communications.

In certain embodiments, processor 510 is interconnected by communication link 515 to antenna 110. Autonomous vehicle controller 500 wirelessly communicates bi-directionally with autonomous vehicle 120, autonomous vehicle 130, and autonomous vehicle 140 via antenna 110. FIG. 1 shows three autonomous vehicles in wireless communication with autonomous vehicle controller 500. FIG. 1 should not be taken as limiting. In actual implementation, autonomous vehicle controller is simultaneously in continuous bi-directional communication with a plurality of autonomous vehicles.

In the illustrated embodiment of FIG. 5, microcode 522, instructions 524, unique ID number 526, drone facility ID 527, hanger ID 528, and task database 529, are encoded in memory 520. In certain embodiments, memory 520 comprises non-volatile memory. In certain embodiments, memory 520 comprises battery backed up RAM, a magnetic hard disk assembly, an optical disk assembly, and/or electronic memory. By “electronic memory,” Applicants mean a PROM, EPROM, EEPROM, SMARTMEDIA, FLASHMEDIA, and the like.

Processor 510 uses microcode 522 to operate autonomous vehicle controller 500. Processor 510 uses microcode 522, instructions 524, to operate Blue Tooth module 540, and wireless communications module 550.

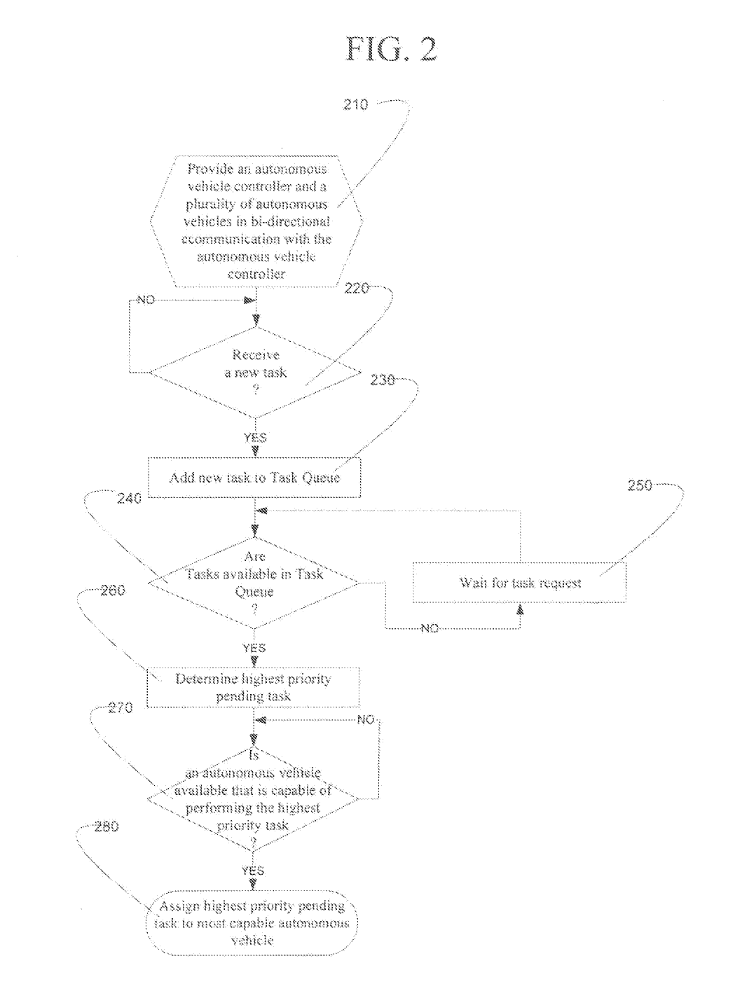

Referring now to FIGS. 1 and 2, in step 210 Applicants' method provides an autonomous vehicle controller 500 configured to communicate bi-directionally with a plurality of autonomous vehicles 120, 130, and 140. FIG. 1 shows three different drones. This aspect of FIG. 1 should not be taken as limiting. In certain embodiments, the plurality of autonomous vehicles comprises two or more autonomous aircraft, and/or two or more autonomous maritime vehicles, and/or two or more powered terrestrial vehicles.

In step 220, the method waits to receive a new task. In step 230, the autonomous vehicle controller adds those one or more new tasks to task queue 529 (FIG. 1).

In step 240, the method determines if tasks are available in task queue 529. When Tasks are not available in Task Queue 529, in step 250 the autonomous vehicle controller waits for task requests. When Tasks are available in Task Queue 529, in step 260 the autonomous vehicle controller identifies a highest priority pending task.

In step 270, the autonomous vehicle controller determines if an available autonomous vehicle that is capable of performing the highest priority task is available. In step 280, the autonomous vehicle controller assigns the highest priority task to the most capable autonomous vehicle. When in step 270 the autonomous vehicle controller determines that there is no available autonomous vehicle that is capable of performing the highest priority task, the method pauses at step 270 until a capable autonomous vehicle becomes available.

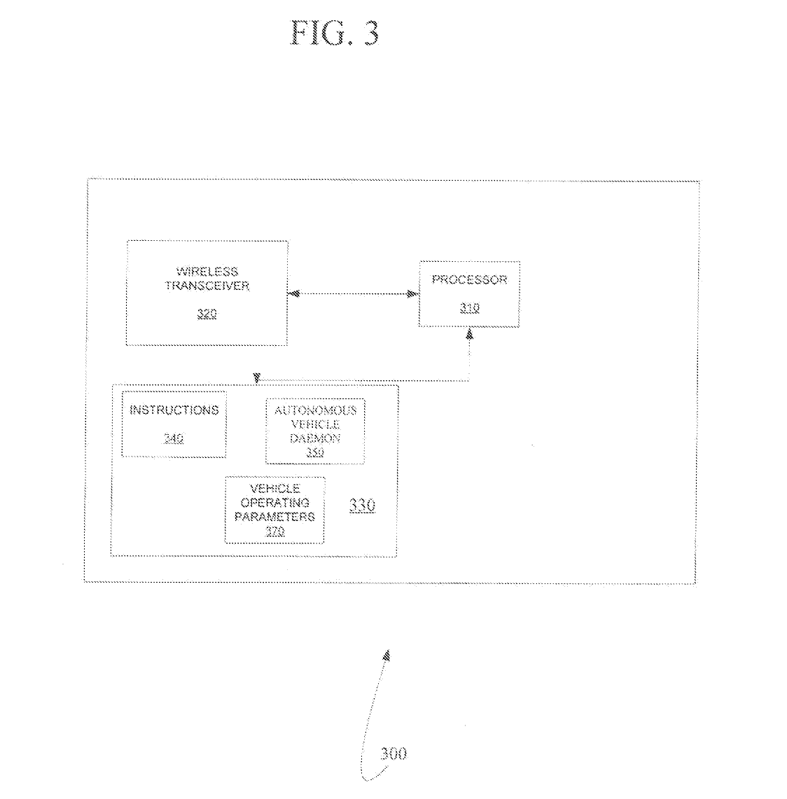

Referring now to FIG. 3, autonomous vehicle 300 comprises processor 310, wireless transceiver 320 interconnected with processor 310 via communication link 325, and non-transitory computer readable memory 330 interconnected with processor 310 via communication link 335. By way of example and not limitation, wireless transceiver 320 may utilize a cellular service, WI-FI, or any other wireless communication protocol.

In the illustrated embodiment of FIG. 3, instructions 340, autonomous vehicle daemon 350, task queue 360, and vehicle operating parameters 370 are encoded in memory 330. In certain embodiments, memory 330 comprises non-volatile memory. In certain embodiments, memory 330 comprises battery backed up RAM, a magnetic hard disk assembly, and optical disk assembly, and/or electronic memory. By “electronic memory,” Applicants mean a PROM, EPROM, EEPROM, SMARTMEDIA, FLASHMEDIA, and the like.

Processor 310 uses autonomous vehicle daemon 350 to operate autonomous vehicle 300. Processor 310 uses instructions 340, autonomous vehicle daemon 350, task queue 360, and vehicle operating parameters 370.

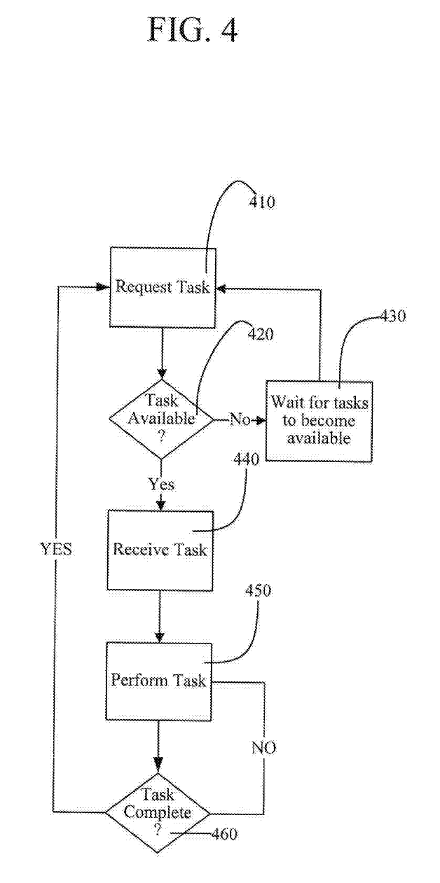

Referring now to FIG. 4, the UAV Daemon requests a task (410) assigned to said UAV from the UAV controller. The daemon determines whether an assigned task is available 420. If no task is available, the daemon waits or a task to become available (430) and requests a task again. If a task is available, the daemon receives the task from the UAV controller (440). The UAV then performs the task 450. The UAV daemon determines whether the task is complete or not 460. If the task is not complete, the UAV continues to perform the task until complete. If the task is complete, the UAV daemon requests another task (410).

While the preferred embodiments of the present invention have been illustrated in detail, it should be apparent that modifications and adaptations to those embodiments may occur to one skilled in the art without departing from the scope of the present invention.

We claim:

1. A method to simultaneously control a plurality of autonomous vehicles, comprising:
providing (N) autonomous vehicles, wherein (N) is greater than or equal to 1, wherein an (i)th autonomous vehicle comprises an (i)th processor, an (i)th non-transitory computer readable medium having (i)th computer readable code encoded therein, and an (i)th autonomous vehicle task queue, wherein (i) is between 1 and (N);
providing an autonomous vehicle controller comprising a controller processor, a controller non-transitory computer readable medium, having controller computer readable code encoded herein, and a controller task queue
wirelessly providing a task to an (i)th autonomous vehicle;
wirelessly providing a task completion message from said (i)th autonomous vehicle to said autonomous vehicle controller.

2. The method of claim 1, further comprising:
determining a highest priority task in said controller queue;
determining which autonomous vehicle can complete said task in the most efficient manner;
wirelessly providing said highest priority task to said autonomous vehicle.

3. An autonomous vehicle, comprising a processor, a non-transitory computer readable medium, and computer readable program code encoded in said non-transitory computer readable medium, to receive and perform one or more tasks from an autonomous vehicle controller, the computer readable program code comprising a series of computer readable program steps to effect:
wirelessly receiving a task from an autonomous vehicle controller;
performing said task by said autonomous vehicle;
wirelessly providing a task completion message from said autonomous vehicle to said autonomous vehicle controller.

4. The autonomous vehicle of claim 3, wherein said processor, non-transitory computer readable medium, computer readable program code, and autonomous vehicle task queue, are disposed in an integral assembly comprising an application specific integrated circuit.

5. The autonomous vehicle of claim 3, the computer readable program code further comprising a series of computer readable program steps to effect wirelessly providing navigational information to said autonomous vehicle controller.

6. The autonomous vehicle of claim 3, the computer readable program code further comprising a series of computer readable program steps to effect wirelessly providing data gathered by said autonomous vehicle, including pictures, video, and sound recording.

7. The autonomous vehicle of claim 5, wherein said navigational information comprises sensor data including current battery capacity, fuel levels, mechanical failures, electronic failures, and computing failures of said autonomous vehicle.

8. The autonomous vehicle of claim 5, wherein said navigational information comprises position, altitude, direction, and speed, of said autonomous vehicle.

9. A computer program product encoded in a non-transitory computer readable medium disposed in an autonomous vehicle comprising a microprocessor, said computer program product being useable with said microprocessor to receive and perform one or more tasks from an autonomous vehicle controller, comprising:
computer readable program code which causes said programmable processor to wirelessly receive a task from an autonomous vehicle controller;
computer readable program code which causes said programmable processor to perform said task by said autonomous vehicle;
computer readable program code which causes said programmable processor to wirelessly provide a task completion message from said autonomous vehicle to said autonomous vehicle controller;
computer readable program code which causes said programmable processor to wirelessly provide task failure message to said autonomous vehicle controller.

10. An autonomous vehicle controller, comprising a processor, a non-transitory computer readable medium, computer readable program code encoded in said non-transitory computer readable medium to simultaneously control a plurality of autonomous vehicle, the computer readable program code comprising a series of computer readable program steps to effect:
wirelessly providing a task to a first autonomous vehicle;
when receiving a task completion message from said first autonomous vehicle, marking said task in said controller task queue as completed;
when not receiving a task completion message from said first autonomous vehicle, assigning said task to a second autonomous vehicle.

11. A computer program product encoded in a non-transitory computer readable medium disposed in an autonomous vehicle controller comprising a microprocessor, and a controller task queue, said computer program product being useable with said microprocessor to simultaneously control a plurality of autonomous vehicle, comprising:
computer readable program code which causes said programmable processor to wirelessly provide a task to a first autonomous vehicle;
computer readable program code which, when receiving a task completion message from said first autonomous vehicle, causes said programmable processor to mark said task in said controller vehicle task queue as completed;
computer readable program code which, when not receiving a task completion message from said first autonomous vehicle, causes said programmable processor to assign said task to a second autonomous vehicle.
